(19) United States
(12) Patent Application Publication
(10) Pub. No.: US 2007/0143805 A1
(43) Pub. Date: Jun. 21, 2007

(54) Digital receiver interface

(75) Inventors: Thaddeus C. Pritchett, Edmonds, WA (US); Jan M. Hofmeyr, Rancho Santa Fe, CA (US); Kenneth Reneris, Bellevue, WA (US); Timothy S. Milligan, Redmond, WA (US); Luc Vantalon, Sunnyvale, CA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/294,045

(22) Filed: Dec. 5, 2005

(51) Int. Cl. H04N 7/173

(52) U.S. Cl. 725/110; 725/112; 725/113

(57) ABSTRACT

An interface device to a broadcast medium uses the Internet Protocol communication layer to communicate with other devices on a network. The device may be associated with a single controlling device on the network, through which other devices on the same network may query and schedule the interface device. The interface device may accept several sources of broadcast or other media, including video and audio, and prepare and normalize the content for used by other devices. Several different physical interfaces may be used to subsequently convert the Internet Protocol communications into useful content streams for various devices, including storage and rendering devices.

### BACKGROUND

a. Technical Field

The present invention pertains generally to receiving broadcast media and specifically to reception and management of broadcast content.

b. Description of the Background

Broadcast content is often encoded and made available to subscribers through a decoding device. The decoding device is able to decode the broadcast signal into a usable form for the subscriber. One example of this technology is a cable television set top box. Each set top box may have some sort of unique identifier that is used by the content provider to determine which portions of the broadcast content, if any, should be made available to the subscriber. Such devices are also used for satellite television, data, and radio broadcasts.

Existing devices are difficult to integrate into a home media network. Some content may be received through a set top box may be copy protected or have some restrictions on the use of the content. When that content is used in a home media environment, the content may need to be used pursuant to a licensing agreement, statute, or other restrictions that limit the use of the content.

Further, the integration is complicated by various electrical interfaces that may connect the set top box or other receiver device to a media server device. Direct connections, such as USB, IEEE 1394, or other standards may be used, as well as network connections such as Ethernet.

### SUMMARY

An interface device to a broadcast medium uses the Internet Protocol communication layer to communicate with other devices on a network. The device may be associated with a single controlling device on the network, through which other devices on the same network may query and schedule the interface device. The interface device may accept several sources of broadcast or other media, including video and audio, and prepare and normalize the content for used by other devices. Several different physical interfaces may be used to subsequently convert the Internet Protocol communications into useful content streams for various devices, including storage and rendering devices.

By using an IP interface, several different physical connections may be made with the device. For example, hardwired Ethernet connections, wireless Ethernet, USB, IEEE1394, or any other type of IP supported interface may be created. A family of devices with the same underlying architecture may have a full functional certification performed at the IP level. Subsequent certification of further models with different physical interfaces may only require the certification of the physical interface, rather than a complete recertification of the entire device.

An IP based interface device can provide many advantages when used in a network environment. These include being able to share the interface device with other devices and users on the network. Because the interface device is attached to a network, several other devices may be able to recognize the device and use the device as a resource. In some embodiments, a relationship may be established between a controlling device and the interface device. In such a case, other devices on the network may be able to schedule and connect to the interface device through the controlling device. In some cases, some authentication, access control, decoding, or other functions may be performed by the controlling device.

### BRIEF DESCRIPTION OF THE DRAWINGS

In the drawings,

FIG. 1 is a diagrammatic illustration of an embodiment showing a media server/receiving device network.

FIG. 2 is a diagrammatic illustration of an embodiment showing the network communications for a media network.

FIG. 3 is a flowchart illustration of an embodiment of a method for handling copy protected content.

FIG. 4 is a diagrammatic illustration of an embodiment showing a media network.

FIG. 5 is a diagrammatic illustration of an embodiment showing a receiver device.

### DETAILED DESCRIPTION

While the invention is susceptible to various modifications and alternative forms, specific embodiments of the invention are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. In general, the embodiments were selected to highlight specific inventive aspects or features of the invention.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The invention may be embodied as devices, systems, methods, and/or computer program products. Accordingly, some or all of the invention may be embodied in hardware and/or in software (including firmware, resident software, micro-code, state machines, gate arrays, etc.) Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the invention is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

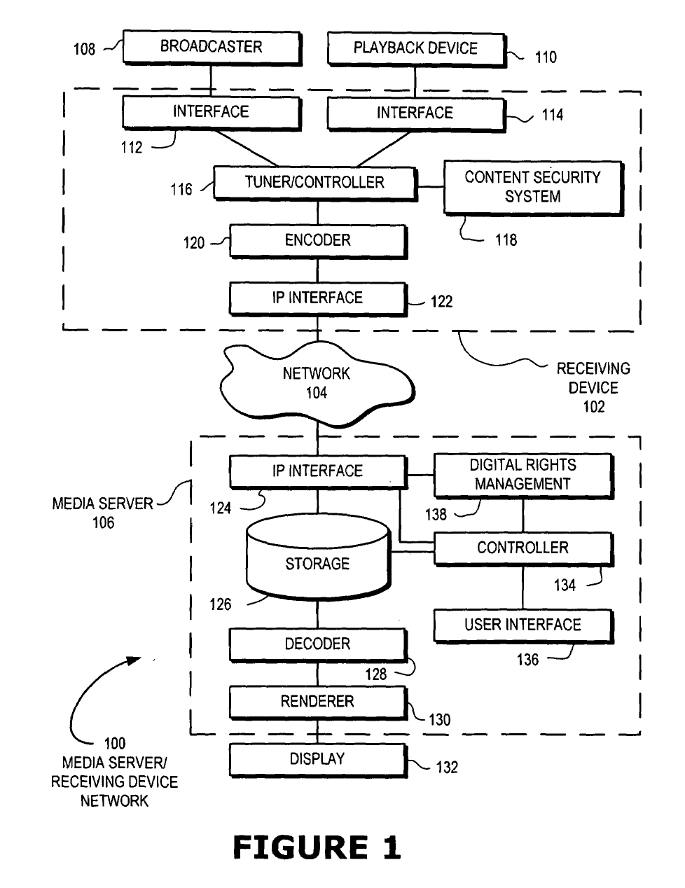

FIG. 1 is a pictorial representation of an embodiment 100 showing a media server in a networked environment. The receiving device 102 is connected through a network 104 to a media server 106. The receiving device 102 may receive content from different sources, such as broadcast content 108 or prerecorded content off of a playback device 110, through the interfaces 112 and 114, respectively. A tuner/controller 116 may select the appropriate channels from an input stream and determine, with the content security system, whether the user has permission to view the content. If so, the content is sent to an encoder 120 and an internet protocol (IP) interface 122 for transmission to the media server 106.

Content is received by the media server 106 through the IP interface 124 and stored in the storage 126. Content that is to be viewed passed through the decoder 128 and the renderer 130 to be passed to the display 132. The controller 134 may have a user interface 136 through which the system may be controlled. A digital rights management system 138 may be used to control the use of some protected content in the storage 126.

The embodiment 100 shows a media server 106 that may control a receiving device 102 in an integrated fashion. Through the network 104, the media center 106 may establish a secure and exclusive relationship with the receiving device 102. The relationship may enable copy protected content to be received by the receiving device 102, transferred to the media center 106 in a secure fashion, and be handled pursuant to the digital rights management system 138. The user interface and control functionality are performed on the media server 106, and commands are transferred to the receiving device 102 via the IP interfaces 122 and 124. Content data is transferred to the media server 106 for storage and display.

The receiving device 102 may comprise a subset of the functionality of a conventional set top box receiver. The tuner/controller 116 may select a channel from a broadcast input stream, such as a cable television network, satellite broadcast signal, terrestrial antenna, or any other broadcast signal. Using the content security system 118, the content may be enabled or disabled.

The content security system 118 may determine which channels, programs, or other content are permitted to be received by the receiving device 102. The content security system 118 may include devices such as a cable access card, smart card, electronic identification number, or any other identification mechanism. The content security system 118 may also include a list of permitted channels that may be viewed by the receiving device 102. In some cases, the receiving device 102 may communicate over a network, such as a cable television network, to an upstream device that may grant or deny permissions for various channels, programs, or other content. In some embodiments, the content security system 118 may be a conventional conditional access system used in satellite or cable television systems. The content security system may include access control to pay per view programming as well as continuously broadcast programming.

The IP interfaces 122 and 124 may be any type of physical layer interface that supports Internet Protocol (IP). The interface may be a direct connection, such as a IEEE 1394 direct cable, a connection to a larger network such as Ethernet, or any other physical layer that supports IP. In some embodiments, the IP interfaces 122 and 124 may be a point to point connection, a broadcast connection, or a multicast connection.

The media server 106 may be a general purpose computer or a specialized device that handles the user interface and control of the receiving device 102. In some cases, the media server 106 may incorporate a display 132, while in other cases, the media server 106 may only distribute programming to other devices that render and display the content.

The media server 106 may incorporate a storage system 126 for recording programming for later playback. In some cases, the storage system 126 may be capable of storing many hours of programming. The programming may be stored and retrieved at a later time to be viewed on the display 132 or on another device connected to the media server 106. Program content that is copy protected may be used and distributed pursuant to the digital rights management system 138.

The digital rights management system 138 may control the use and distribution of copy protected content by any method. In some cases, copy protected content is marked as such and various systems for permitting or denying access or manipulation of the content may be used to control the content. In other cases, copy protected content may be stored in a separate storage system 126 and made available using different permissions than with non-copy protected content. Several digital resource management systems are commercially available and may be adapted to various embodiments. In some embodiments, two or more different digital rights management systems may be used.

The user interface 136 for the media server 106 may be any method or device that enables a user to send commands and retrieve information from the media server 106. In some cases, the media server 106 may display relevant information on the display 132 that is used for viewing content. In other cases, the user interface 136 may display information on a separate display. The user interface 136 may include any type of input device, such as a remote control, mouse, keyboard, pointer, button pad, or any other input device. In some cases, the functions of the user interface 136 may be performed by another device connected to the media server 106 through a network or other communications medium.

The encoder 120 and decoder 128 may be used to convert the incoming signals into a format that is capable of transmitting across the IP interfaces 122 and 124. In many systems, the encoder 120 may encode the incoming signals into an intermediate standard format, such as ITU-R BT.656 or some other format. The decoder 128 may convert from the intermediate standard format to a format compatible with the display 132. Examples of the resulting format may include NTSC, PAL, or SECAM. Various resulting formats and intermediate formats may be used in various embodiments. The renderer 130 may take the decoded format and present the content on an interface compatible with the display 132.

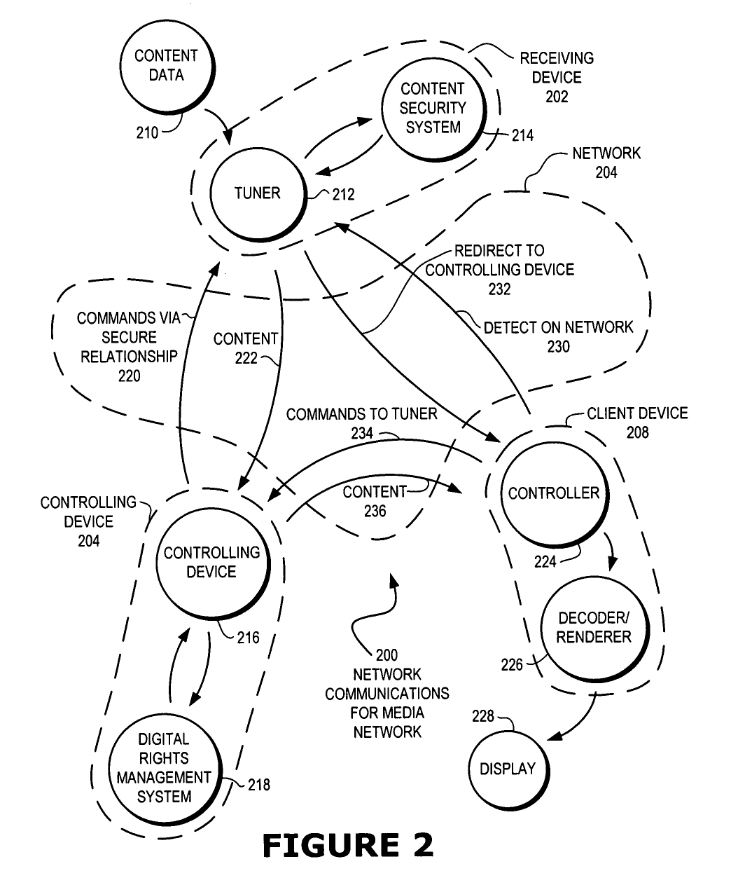

FIG. 2 illustrates an embodiment 200 showing the network communications for a media network. A receiving device 202 communicates over a network 204 that contains a media server 206 and a client device 208. The receiving device 202 may receive content data 210 through the tuner 212 and provide an initial layer of content security or access permissions through the content security system 214.

The controlling device 206 may incorporate the controlling device 216 established to control and communicate with the receiving device 202, as well as contain a digital rights management system 218 for controlling the use of content over devices connected to the network 204. The controlling device 216 may send commands via a secure relationship 220 to the receiving device 202 and receive content 222.

The client device 208 may include a controller 224 and a decoder/renderer 226 that prepares the content data 210 to be shown on the display 228. Since all the various devices are on the network 204, the client device 208 may detect 230 that the receiving device 202 is available and on the network 204. Because a controlling relationship has been established between the media server 206 and the receiving device 202, the receiving device 202 may send instructions 232 to the client device 208 that redirects requests to the controlling device 216. The client device 208 may send commands 234 for the tuner to the controlling device 216, which then commands the receiving device 202. The tuner 212 may send content 222 to the controlling device 216 that in turn forwards the content 236 to the controller 224.

The embodiment 200 illustrates how devices connected to the network 204 may access the content 210 yet the various copy protection and access control systems may ensure that the content is properly secure. The receiving device 202 may establish a relationship with the media server 206. The media center 206 may then be the exclusive device that is permitted to send commands to the receiving device 202. When another device such as the client device 208 requests services from the receiving device 202, the client device 208 is redirected to send commands to the media server 206.

An exclusive relationship between the media server 208 and receiving device 202 may be established when the media server 206 has a digital rights management system 218 available to control copy protected content. The copy protected content may be accessible to the client device 208, however the content may be first processed by the digital rights management system 218 prior to being used by the client device 208.

A controlling relationship may exist between the media server 208 and the receiving device 202. As such, the receiving device 202 may accept commands only from the media server 208, and ignore requests from other devices. When another device such as the client device 208 contacts the receiving device 202, the receiving device 202 may redirect requests to the device having the controlling relationship, in the present case the media server 208.

In some embodiments, the content 210 travels from the receiving device 202 to the media server 206 before being transferred to the client device 208. In other embodiments, once the client device 208 has requested the content through the media server 206 and the request has been permitted by the digital rights management system 218, the content may be transmitted directly from the receiving device 202 to the client device 208. Such an embodiment may reduce the amount of network traffic and may be useful in a home network environment or other locations where bandwidth may be at a premium.

The media server 206 may provide scheduling and conflict resolution between various network devices that request services from the receiving device 202. Various scheduling methods may be used to determine the actions taken by the receiving device and the prioritization of commands sent from different client devices.

The client device 208 may be a general purpose computer system, dedicated hardware device, built in device in a television display, or any other architecture. In some embodiments, the client device 208 may have a user interface comprising a display and some form of user input. In an example of a television with a built in client device, an onscreen display and multi-button remote control may serve as a user interface. The user may be able to select programming or other content available from the receiving device 202 using a user interface on the client device 208.

The network 204 may be any form of communication network. A common network used in local area networks and wide area networks is Ethernet, which may use Internet Protocol. In some cases, TCP/IP or UDP may be used. In some embodiments, the entire network 204 may be a local area network in a user's home. In other embodiments, all or a portion of the network 204 may be the Internet, with one or more of the receiving device 202, media server 206, and/or client device 208 located remotely from each other via the Internet.

The content 222 and 236 may be encrypted content. In some embodiments, copy protected content may be encrypted in one manner while non-copy protected content may be unencrypted or encrypted in a different manner than copy protected content. Content may be encrypted by the receiving device 202 or by the media server 206. In some cases, content may be first encrypted by the receiving device 202, decrypted by the media server 206, and encrypted again by the media server 206 using a different encryption method or key. Various encryption schemes, including no encryption at all, may be used with the embodiment 200.

In some embodiments, the client device 208 may comprise a digital rights management system similar to the digital rights management system 218 of the controlling device 204. In such an embodiment, the client device 208 may request that the exclusive relationship between the controlling device 204 and the receiving device 202 may be transferred to the client device 208. When this occurs, the client device 208 may exclusively communicate with the receiving device 202.

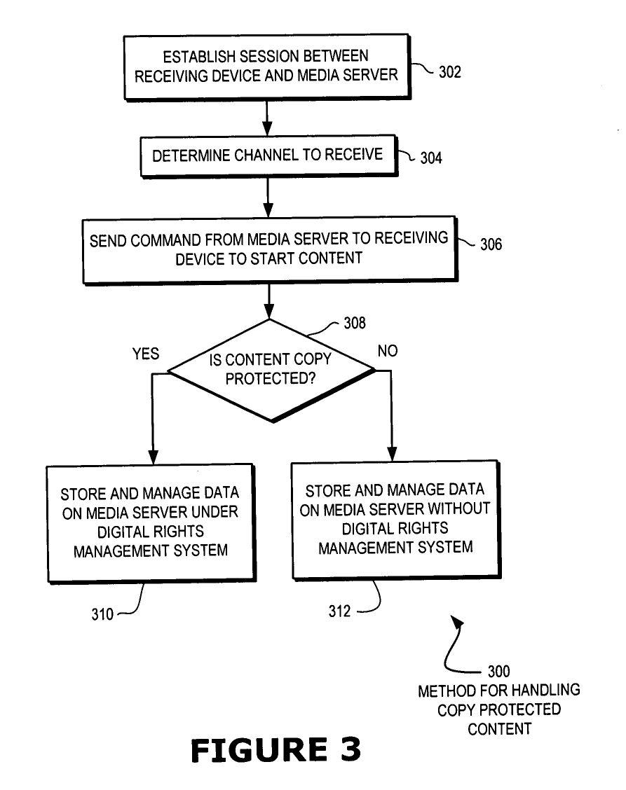

FIG. 3 is a flowchart illustration of embodiment 300 showing a method for handling copy protected content. A session is established between the receiving device and a media server in block 302. The channel to receive is determined in block 304 and a command is sent from the media server to the receiving device to begin transmitting content in block 306. If the content is copy protected in block 308, the content is stored and managed on the media server under a digital rights management system in block 310. If the content is not copy protected in block 308, the content is stored and managed on the media server without the digital rights management system in block 312.

The embodiment 300 illustrates a method whereby copy protected content may be identified and managed under a digital rights management system. In some embodiments, the receiving device may receive content from prerecorded media such as prerecorded DVD disks or other media. Such content may have copy protection identification and may be managed and used under a digital rights management system. In other cases, specific content received on a broadcast medium such as cable television distribution or satellite distribution systems may be copy protected. This may include pay per view or other special ordered content. In some cases, all or a majority of the content used by the media server may be managed under a digital rights management system.

A digital rights management system may set limits or permissions for various activities performed on content. For example, a digital rights management system may cause a particular program to expire after a certain time or a certain number of views. In some cases, a digital rights management system may permit a program to be recorded by a client device having recording capabilities. Such recording may be limited to a certain number of recordings or may require that the content be recorded using specific settings, such as settings that require the recording to be identified as copy protected, settings that determine the resolution or quality of the recording, or any other setting desired.

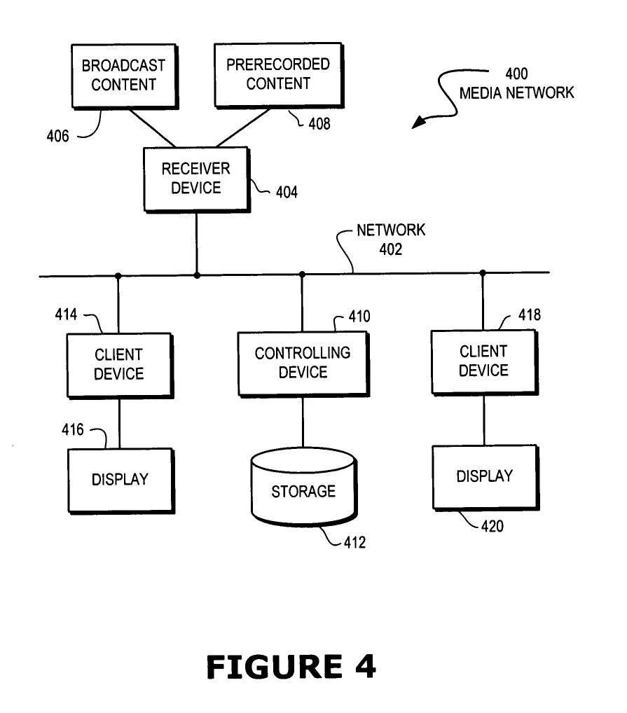

FIG. 4 is a diagrammatic illustration of an embodiment 400 of a media network. An IP network 402 may be an Ethernet or other IP network. A receiver device 404 may take broadcast content 406 or prerecorded content 408 and make it available to devices on the network 402. A controlling device 410 may establish a controlling relationship with the receiver device 404 and be capable of sending commands and performing scheduling and other functions for the receiver device 404. Client device 414 with display 416 and client device 418 with display 420 may communicate with the controlling device 410 and receiver device 404 over the network 402.

The embodiment 400 may be a typical arrangement for a home media network. A controlling device 410 may be a media server such as a general purpose computer with storage 412. A media server may also be a dedicated device that is located on the network and may or may not have a user interface or a display for viewing content. The client devices 414 and 418 may be network interface and controlling devices attached to a television display or any other type of client device capable of communicating on the network.

In some embodiments, two or more receiving devices 404 may be present on the network 402. In such cases, a single controlling device 410 may control and schedule all of the receiving devices, or separate controlling devices may be assigned to each receiving device. When a single controlling device 410 is used to control multiple receiving devices, the controlling device 410 may distribute requests for content from multiple client devices to multiple receiving devices.

The client device 414 or controlling device 410 may include a recording mechanism, such as a DVD writer or other recording technology. In such a case, the controlling device 410 may permit or deny a recording depending on any copy protection mechanisms in place for the particular content.

The controlling device 410 may store content in an attached storage system 412. In such a case, the attached storage system may be a disk drive or bank of disk drives capable of storing content. In some embodiments, a storage system may be located on another device attached to the network 402. In still other embodiments, the storage of media content may be distributed amongst different client devices 414 and 418 in addition to the controlling device 410.

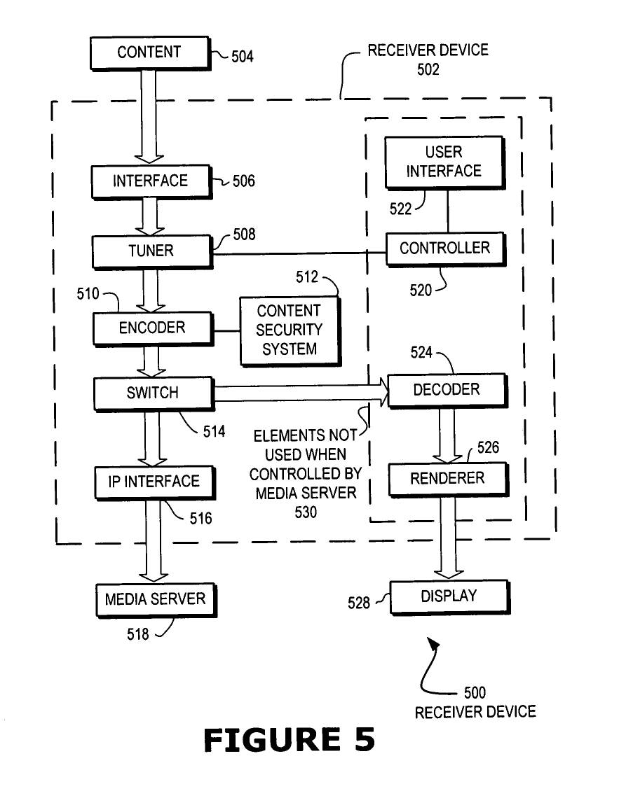

FIG. 5 is a diagrammatic illustration of an embodiment 500 showing a receiver device. The receiver device 502 takes the incoming content 504 through the interface 506. A tuner 508 selects a channel from the incoming stream, processes the signal through an encoder 510, for which permission is obtained through a content security system 512. The switch 514 may be enabled to pass the signal through an IP interface 516 and to the media server 518.

When the receiver device 502 operates as a stand alone set top box, the controller 520 may direct the tuner 508 based on a user interface 522. In this mode, the switch 514 may direct the content signal to a decoder 524, a renderer 526, and then to a display 528.

The embodiment 500 illustrates a set top box that may be used with a media server 518 or as a conventional stand alone set top box. When being controlled by a media server 518, the signal path is through the IP interface 516 and to the media server 518. In such a case, the elements 530 may be unused and the signals containing the content may be directed to the media server 518. When functioning as a stand alone set top box, the operation of the set top box is controlled through the controller 520 and user interface 522. In that mode, the switch 514 is activated such that the signals are not sent through the IP interface 516, but instead travel through the decoder 514 and renderer 516 to the display 528.

In some embodiments, a set top box receiver device 502 may be a useful implementation, especially when it is anticipated that deployment of new cable television or satellite television services may use a home media server 518 for content management within the home.

The IP interface 516 may include any interface for which the Internet Protocol is operable. Because the high level protocol is IP, a particular embodiment of the receiving device 502 may be built and tested using IP communication standards over the interface 516. When a new version of the same device is built with a different physical IP interface 516, the testing and certification of the new version may only need to include certification of the new physical interface, since all of the higher level communication will have been previously certified.

In a typical embodiment with an analog television waveform, the encoder 510 may digitize the waveform into a digital encoded stream. In an embodiment with digital television waveforms, the encoder 510 may demodulate a digital television waveform.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device comprising:
a broadcast media interface adapted to receive a broadcast signal comprising a plurality of transmission channels;
a tuner adapted to select at least one of said transmission channels and transmit a channel signal;
a broadcast security system adapted to either allow or disallow specific ones of said transmission channels to be transmitted;
an Internet Protocol interface;
an Internet Protocol encoder adapted to translate said channel signal into packets and transmit said packets to a first network device via said Internet Protocol interface; and
a controller adapted to receive commands for said tuner, said first network device further comprising a digital rights management system adapted to receive copy protected content from said channel signal to said first network device, said copy protected content being permitted by said digital rights management system in conjunction with said broadcast security system.

2. The device of claim 1, said controller further adapted to:
establish communications to a second network device;
transmit information regarding said first network device to said second network device; and
respond to commands sent from said second network device to said first network device to said device.

3. The device of claim 1 wherein said broadcast signal comprises at least one of a group composed of audio, video, and data signals.

4. The device of claim 1 wherein said broadcast signal comprises at least one of a group composed of cable television signals, terrestrial broadcast signals, satellite, or Internet Protocol broadcast signals.

5. The device of claim 1 wherein said broadcast security system comprises a removable access card.

6. The device of claim 1 wherein said Internet Protocol interface comprises at least one of a group composed of a broadcast connection, a point to point connection, and a multicast connection.

7. The device of claim 1 wherein said controller is further adapted to receive a request for transfer of control from a second network device and respond to commands from said second network device.

8. A system comprising:
a receiving device comprising a broadcast media interface adapted to receive a broadcast signal comprising a plurality of transmission channels, a tuner adapted to select at least one of said transmission channels and transmit a channel signal, a broadcast security system adapted to either allow or disallow specific ones of said transmission channels to be transmitted, an Internet Protocol interface, an Internet Protocol encoder adapted to translate said channel signal into packets and transmit said packets via said Internet Protocol interface; and
a first network device comprising an Internet Protocol interface connected to said Internet Protocol interface of said receiving device, a digital rights management system adapted to receive copy protected content from said channel signal to said first network device, said receiving being granted by said digital rights management system in conjunction with said broadcast security system of said receiving device.

9. The system of claim 8 comprising a second network device wherein said receiving device is further adapted to:
establish communications to said second network device;
transmit information regarding said first network device to said second network device; and
respond to commands sent from said second network device to said first network device to said receiving device.

10. The system of claim 8 wherein said broadcast signal comprises at least one of a group composed of audio, video, and data signals.

11. The system of claim 8 wherein said broadcast signal comprises at least one of a group composed of cable television signals, terrestrial broadcast signals, satellite, and Internet Protocol broadcast signals.

12. The system of claim 8 wherein said broadcast security system comprises a removable access card.

13. The system of claim 8 wherein said Internet Protocol interface comprises at least one of a group composed of a broadcast connection, a point to point connection, and a multicast connection.

14. The system of claim 8 wherein said receiving device is further adapted to receive a request for transfer of control from a second network device and respond to commands from said second network device.

15. A method for controlling a receiving device comprising:
establishing a session with said receiving device with a first network device through a first connection using Internet Protocol;
sending a tuner command from said first network device to said receiving device, said receiving device being adapted to select at least one of a plurality of transmission channels being received on a broadcast media interface;
determining that copy protected content is being received on at least one of a said plurality of transmission channels;
permitting said copy protected content to be transmitted based on a digital rights management system on said first network device and a broadcast security system on said receiver device; and
transmitting said copy protected content from said receiver device to said first network device on said first connection.

16. The method of claim 15 further comprising:
establishing communications with a second network device by said receiver device;
transmitting information regarding said first network device to said second network device; and
responding to commands sent from said second network device to said first network device to said receiving device.

17. The method of claim 15 wherein said broadcast signal comprises at least one of a group composed of audio signals and video signals.

18. The method of claim 15 wherein said broadcast signal comprises at least one of a group composed of cable television signals, terrestrial broadcast signals, satellite broadcast signals, and Internet Protocol broadcast signals.

19. The method of claim 15 wherein said Internet Protocol interface comprises at least one of a group composed of a broadcast connection, a point to point connection, and a multicast connection.

20. The method of claim 15 wherein said receiving device is further adapted to receive a request for transfer of control from a second network device and respond to commands from said second network device.
